(19) United States
(12) Patent Application Publication
(10) Pub. No.: US 2021/0164806 A1
(43) Pub. Date: Jun. 3, 2021

(54) SMART COVER FOR PROXIMITY-BASED UTILITY METER READING AND PAYMENT PROCESSING

(71) Applicant: Netclearance Systems, Inc., Escondido, CA (US)

(72) Inventor: David Fernandez, Escondido, CA (US)

(73) Assignee: Netclearance Systems, Inc., Escondido, CA (US)

(21) Appl. No.: 17/111,416

(22) Filed: Dec. 3, 2020

Related U.S. Application Data
(60) Provisional application No. 62/942,790, filed on Dec. 3, 2019.

(51) Int. Cl. G01D 4/00; G06Q 10/06; G06Q 30/04; G06F 21/57

(52) U.S. Cl. CPC G01D 4/008; G01D 4/002; G06Q 50/06; G06Q 30/04; G06F 21/572; G06Q 10/06315

(57) ABSTRACT

A retrofit module provides wireless communication capability to legacy utility meters. A smart cover or other retrofit module may be used to upgrade existing legacy meters. The retrofit module may communicate with the utility meter via a local connection. The retrofit module may be able to receive meter data, such as usage information, and send data or instructions to the meter, such as firmware updates. The retrofit module may wirelessly receive and transmit data used for billing, payment, usage monitoring, and/or other functionality to a user device across a local wireless connection (e.g., Bluetooth, Wi-Fi, etc.). Internet-connected user devices (e.g., smartphones, tablets, wearable devices, laptops, etc. are ubiquitous. The retrofit module may utilize such user devices as internet gateways to send and receive data between the utility meter and various network-connected resources (e.g., utility account resources, payment processing resources, etc.).

### CROSS-REFERENCE TO RELATED APPLICATIONS

This application claims priority to U.S. Provisional Patent Application Ser. No. 62/942,790, filed on Dec. 3, 2019. U.S. Pat. No. 9,811,846 B2, issued on Nov. 7, 2017, U.S. Pat. No. 9,933,265 B2, issued on Apr. 3, 2018, U.S. Pat. No. 9,928,536 B2, issued on Mar. 27, 2018, U.S. Pat. No. 10,586,251 B2, issued on Mar. 10, 2020, U.S. Patent publication number 2015/0206096 A1, published on Jul. 23, 2015, U.S. Patent Publication number 2017/0178104 A1, published on Jun. 22, 2017, and U.S. Patent publication number 2018/0150819 A1, published on May 31, 2018, are herein incorporated by reference.

### BACKGROUND

Utility meters (e.g., water, gas, and electric meters) are installed in homes and businesses but not all are internet connected or have access to networks to transmit and receive data that can be used for electronic billing, payments and monitoring, and/or other appropriate functionality. It is expensive and time-consuming to add or replace meters to provide network connectivity.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates an example overview, in which meter data is collected and provided to a user device by a smart cover of some embodiments;

FIG. 2 illustrates an example overview, in which payment is received from a user device by a smart cover of some embodiments;

FIG. 3 illustrates a schematic block diagram of a smart cover of some embodiments;

FIG. 4 illustrates a front perspective view of an exemplary smart cover of some embodiments;

FIG. 5 illustrates a rear perspective view of an exemplary smart cover of some embodiments;

FIG. 6 illustrates a front perspective view of an exemplary smart cover of some embodiments;

FIG. 7 illustrates a flow chart of an exemplary process that provides usage information from a smart cover to a user device and receives updates at the smart cover from the user device;

FIG. 8 illustrates a flow chart of an exemplary process that provides usage information to a user device and processes a payment received from the user device;

FIG. 9 illustrates a flow chart of an exemplary process that receives usage data from a smart cover at a user device and provides updates to the smart cover from the user device;

FIG. 10 illustrates a flow chart of an exemplary process that receives usage data from a smart cover at a user device and processes a payment from the user device to the smart cover; and

FIG. 11 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide an interface that provides wireless communication capability to a legacy utility meter.

Legacy utility meters (e.g., water, gas, and electric meters) that are installed in homes and businesses typically do not have network or wireless communication capabilities. It is expensive and time-consuming to add, replace, or update meters to provide such wireless or network connectivity.

A smart cover or other retrofit module of some embodiments may be used to upgrade existing legacy meters. The retrofit module may be physically coupled to the meter in various appropriate ways (e.g., included in a meter cover).

The retrofit module may communicate with the utility meter via a local connection. The retrofit module may be able to receive meter data, such as usage information, and send data or instructions to the meter, such as firmware updates.

The retrofit module may wirelessly receive and transmit data used for billing, payment, usage monitoring, and/or other functionality to a user device across a local wireless connection (e.g., Bluetooth, Wi-Fi, etc.). Internet-connected user devices (e.g., smartphones, tablets, wearable devices, laptops, etc. are ubiquitous. The retrofit module may utilize such user devices as internet gateways to send and receive data between the utility meter and various network-connected resources (e.g., utility account resources, payment processing resources, etc.).

The user devices (and associated application) may communicate over one or more wide-area networks (e.g., cellular, the Internet, etc.) to a central server or other appropriate resource of some embodiments that is able to perform various actions such as processing billing information, generating a payment request, and processing a payment from the mobile device. The server may send a digital receipt or proof of payment that can then be transferred from the user device to the retrofit module (and utility meter) to complete a payment.

Some existing meters have smart card readers or near field communications (NFC) capabilities. The retrofit module of some embodiments may emulate such a smart card or NFC to communicate with the utility meter. The retrofit module may include various physical connectors, terminals, interfaces, etc. that may be able to be coupled to the utility meter. Such physical connectors may utilize existing terminals, wires, sockets, contact points, etc. of the utility meter such that the retrofit module may be used to update legacy meters with minimal or no modification to the meter. For instance, some embodiments may provide a retrofit cover that replaces an existing cover, such as a snap on or screw-on cover, and utilizes existing contact points of the meter to communicate with the meter.

The retrofit module and associated wireless communication of some embodiments provides various benefits. For instance, there is no need for a plastic smart card or reader in the meter which adds cost. With a smart card reader in the meter the user must carry a plastic smart card to and from the meter to read and write data into and from the meter. Other meters may have broadband connectivity but are expensive and have increased battery or power consumption. As another example, the present solution reduces operating and capital expenditures to the utility company as there is no need to connect the meters to the internet with expensive cellular modems and data plans because the user device acts a short-range internet gateway to send and receive data to and from the meter. Operating costs are also reduced as the utility company does not need to send technicians to read the meters manually (or may read the meter from greater distance). Time is saved for the consumer as the consumer does not need to go to a utility payment center to settle a bill and instead can receive the bill and pay directly from a user device with a payment app from the comfort of their house. It also enables the ability to pre-pay for the utility via the mobile app and transfer digital credits to the meter which can be converted into measures or usage (e.g., kilowatts, liters, etc.) at the meter.

The wireless meter interface increases customer satisfaction and convenience, allows for pre-payment or post-payment on-site (i.e., without needing to visit a payment center), provides energy profile monitoring (e.g., comparison to neighbors, past consumption, etc.), allows management and control of multiple meters (e.g., as needed by landlords or property managers), and allows meter reading from ten to fifty feet away or more. In addition, the smart cover of some embodiments allows existing meters to be easily updated in order to provide the increased functionality described herein.

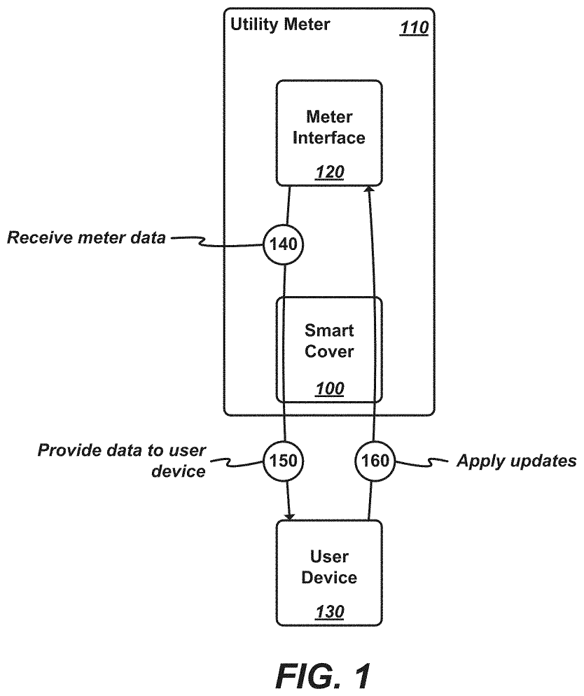

FIG. 1 illustrates an example overview, in which meter data is collected and provided to a user device by a smart cover 100 of some embodiments. Although the smart cover 100 (or references to a “smart cover”) may be used in various examples throughout this disclosure, one of ordinary skill in the art will recognize that the features and functionality described herein may be provided by various other types of retrofit modules that may be configured for use with various types of meters and may be provided in various different housings, packages, etc. For instance, some embodiments may provide a self-contained retrofit module in a small screw-on or stick-on package.

The smart cover 100 may form a portion of the housing of the utility meter 110 and may replace an existing cover. The smart cover 100 may be made from various appropriate materials (e.g., plastic, metal, rubber, etc.).

The utility meter 110 may be a gas, electric, water, or other type of service meter (e.g., sewage). In the context of upgrading existing or legacy utility meters 110 using smart cover 100, the utility meters 110 do not have native wireless communication capabilities and/or other network communication capabilities, such as an Ethernet or other wired connection. As such, the smart cover 100 may provide wireless and/or network connectivity to upgrade such legacy utility meters 110, and any references to “utility meters” 110 throughout this disclosure shall be understood to refer to legacy utility meters 110 that do not include wireless or network connectivity.

As shown, each utility meter 110 may include a meter interface 120. The meter interface 120 may include an interface between the meter and a reader (e.g., an NFC reader) or other device (e.g., an insertable smart card). The meter interface 120 may allow the smart cover 100 to communicate with the meter 110 in order to retrieve usage data, apply payments, update operating parameters, and/or otherwise interact with the meter 100.

As shown in FIG. 1, smart cover 100 may communicate with user device 130. The user device 130 may be a smartphone, tablet, laptop, personal computer, wearable device, and/or any other electronic device that is capable of communicating across a local wireless connection or channel, such as Bluetooth, Wi-Fi, etc. and may also have access to a wide area network. The user device 130 may be associated with a technician or other appropriate user.

As shown, smart cover 100 may receive (at 140) meter data. Such data may be received in various ways in various appropriate formats. For instance, the utility meter 110 may provide signals indicating usage. As another example, the utility meter 110 may provide data indicating usage amounts. The smart cover 100 may calculate or otherwise determine usage based on the received signals or data.

The smart cover 100 may establish a connection to a user device 130. Such a connection may include a wireless communication channel, such as Bluetooth or Wi-Fi. Smart cover 100 may be associated with various connection parameters that may be configured in various appropriate ways. For instance, smart cover 100 may generate a beacon signal using a radio transmitter (e.g., a Bluetooth transmitter, Wi-Fi transmitter, etc.). The transmitter may be configured such that the beacon signal is only detectable within a specified range (e.g., within ten feet, within fifty feet, etc.). The beacon signal may include identifying information associated with smart cover 100 (e.g., a unique serial number) and/or utility meter 110 (e.g., a descriptor of the meter, such as “Type X Electric”).

User device 130 may receive the beacon signal and send a response. The response may include information, such as user device 130 identifying information and/or user (i.e., technician) identifying information (e.g., serial number, badge number, username, etc.), that may be validated by smart cover 100. Such validation may include communication between smart cover 100 and a resource such as a server via user device 130. For instance, the unique identifier of the smart cover 100 may be sent, along with a badge number, passcode, and/or other appropriate information to the server for validation. The server may interact with various other resources to validate the provided information. If the information is valid, a digital certificate, a digitally signed certificate, token, key, or the like may be returned to smart cover 100, which may be validated by smart cover 100. In some cases, the beacon signal may be used to initiate a standard wireless connection (e.g., a Bluetooth connection) without any additional validation of user or device identity.

The smart cover 100 may provide (at 150) the collected data to the user device 130 across the wireless channel. The user device 130 may execute an application or other appropriate resource that may allow selection of the data to be received from the smart cover 100, and/or otherwise interact with the smart cover 100.

The user device 130 may apply (at 160) updates to the utility meter 110 via the smart cover 100 and meter interface 120. Such updates may include, for instance, updates to firmware, changes to operating parameters, updated security information (e.g., validation tokens, encryption and/or decryption keys, etc.), and/or other appropriate information. Such updates may be applied or implemented by the smart cover 100 in some cases. For instance, updates to wireless transmission parameters may be implemented at the smart cover 100.

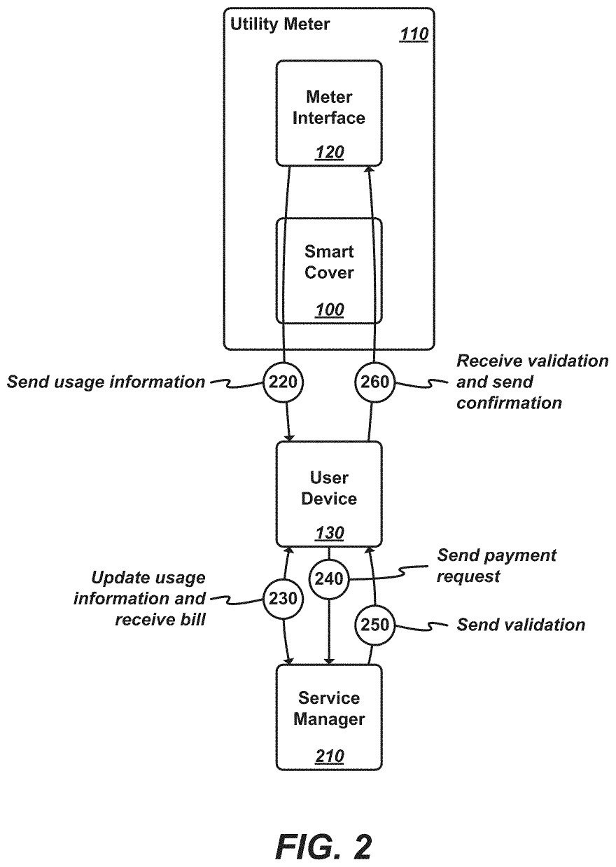

FIG. 2 illustrates an example overview, in which payment is received from a user device 130 by a smart cover 100 of some embodiments. The user device 130 may be associated with a landlord, homeowner, business owner, and/or other appropriate users. The smart cover 100 may establish a connection with the user device 130 in a similar manner to that described above.

Service manager 210 may include a server and/or other appropriate devices that are network accessible and may manage services associated with utility meter 110. Such management may include, for instance, billing, payment processing, usage tracking, etc.

As shown, smart cover 100 may retrieve usage information via meter interface 120 and send (at 220) the usage information to the user device 130. User device 130 may further establish a connection to service manager 210 (e.g., via a cellular network or the Internet) and update (at 230) usage information and receive a bill from the service manager 210 based on the updated information. In some cases, the user device 130 may not receive usage information and may request a bill from the service manager 210 based on technician readings or other previously collected data.

The user device 130 may send (at 240) a payment request (or “validation request”) to the service manager 210. Such a payment request may include, for instance, account identifying information (e.g., user name, account number, etc.), payment amount, payment source (e.g., credit card information, bank account information, cryptocurrency information, etc.).

The service manager 210 may receive and process the payment request. Such processing may include interaction with other resources such as a payment processing server, bank resources, etc. If the payment attempt fails, the service manager 210 may send a message to the user device 130 indicating the result. If the payment is successfully processed, the service manager 210 may send (at 250) a validation message to the user device 130. Such a validation message may include a payment token or other validation credential such as a digitally signed certificate.

The user device 130 may receive (at 260) the validation message and send a confirmation to the smart cover 100. The smart cover 100 may relay the confirmation to the utility meter 110 via meter interface 120. Utility meter 110 may be able to validate or otherwise confirm and apply the payment message. For instance, the utility meter 110 may compare a received token to a list of acceptable tokens. As another example, the utility meter 110 may perform various verification algorithms to verify the authenticity of a token or payment message. Such verification algorithms may be downloaded to the utility meter 110 via a technician device or other appropriate resource.

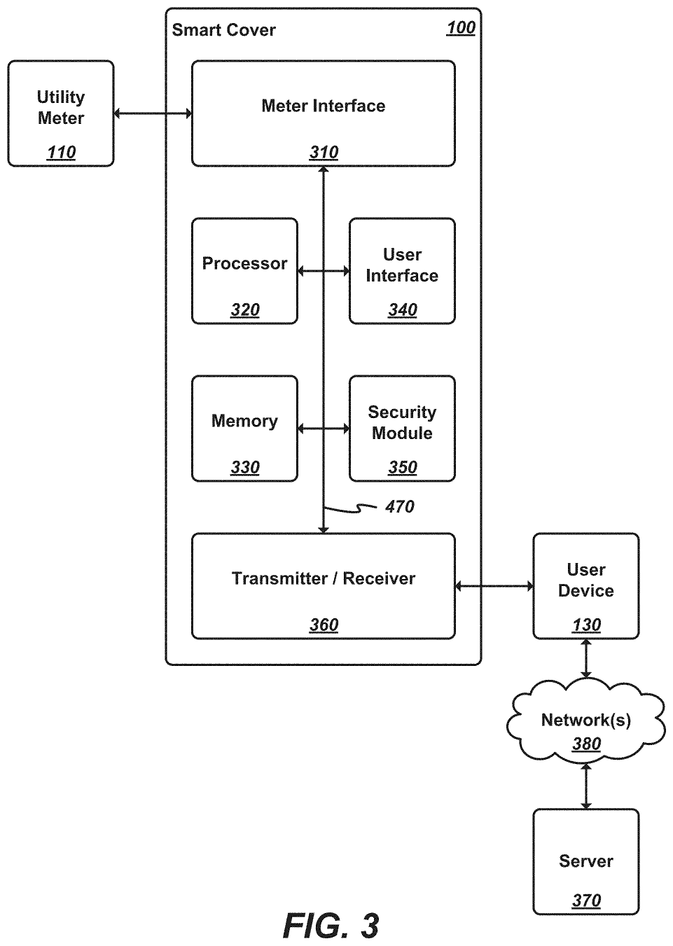

FIG. 3 illustrates a schematic block diagram of a smart cover 100 of some embodiments. As shown, smart cover 100 may include a meter interface 310, one or more processors 320, storage or memory 330, UI 340, security module 350, and transmitter/receiver 360 (or “transceiver”). Smart cover 100 may be implemented as a single device that is able to be installed at legacy utility meters 110 using existing connection features of such utility meters 110 (e.g., cables, sockets, contacts, pins, and/or other connectors).

The meter interface 310 may include various sockets, cables, contacts, pins, and/or other connectors or connection elements that may be able to interface with various components of a utility meter 110, such as processors, data storages, output signals, etc. In some embodiments, meter interface 310 may include an NFC transmitter and/or receiver. The meter interface 310 may be able to couple to utility meter 110 features or components such as a regulated power supply.

Processor 320 may execute instructions and/or otherwise process data. For instance, processor 320 may be able to perform calculations associated with verification of received payment tokens. As another example, processor 320 may be able to at least partly direct operations of utility meter 110, such as enabling or disabling service, via meter interface 310.

Memory 330 may store instructions and/or data. Such instructions may include, for instance, instruction related to digital certificate verification algorithms. Stored data may include usage data, data related to processed transactions (e.g., user device identifiers, username or account number, transaction amount, timestamp, etc.), etc.

UI 340 may include various indicators or features associated with operation of smart cover 100. For instance, UI 340 may include one or more indicator lights (e.g., differently colored light emitting diodes (LEDs)) that may indicate status of the smart cover 100 to a technician or other such user. As another example, UI 340 may include buttons, a keypad, touchscreen, or similar elements that may allow a technician or other user to update meter information.

Security module 350 may evaluate data associated with payment transactions (or other interactions) in order to determine whether any requested transactions should be authorized or performed. For instance, security module 350 may encrypt and/or decrypt data using one or more keys. As another example, security module 350 may be able to evaluate received digital certificates and/or associated signatures to determine whether the data is valid. Security module 350 may be able to interact with various network resources via a user device 130 in order to update evaluation algorithms, keys or other data manipulation elements, validation criteria, etc.

Transmitter/receiver 360 may be able to interact with various user devices 130 and/or other devices via wireless connections in order to perform or otherwise facilitate various cash and/or cryptocurrency transactions. Transmitter/receiver 360 may, for instance, communicate across one or more channels such as a Bluetooth channel, a Wi-Fi connection, a cellular connection, etc.

Transmitter 360 may broadcast a beacon signal that may be received by user devices 130 within a broadcast range of the smart cover 100, where such a range may be selectable or otherwise configurable. Such a beacon signal may include information such as a unique identifier associated with smart cover 100. The beacon signal may be transmitted at regular intervals or based on some transmission criteria.

User device 130 may be able to communicate across various networks 380 (e.g., cellular networks, Wi-Fi, the Internet, etc.) with various servers 370 or other network-accessible systems, devices, or components.

One of ordinary skill in the art will recognize that smart cover 100 may be implemented in various different ways without departing from the scope of the disclosure. For instance, smart cover 100 may include additional components such as a power module (including, for instance, one or more batteries, a solar cell, etc.), a communication interface, etc.

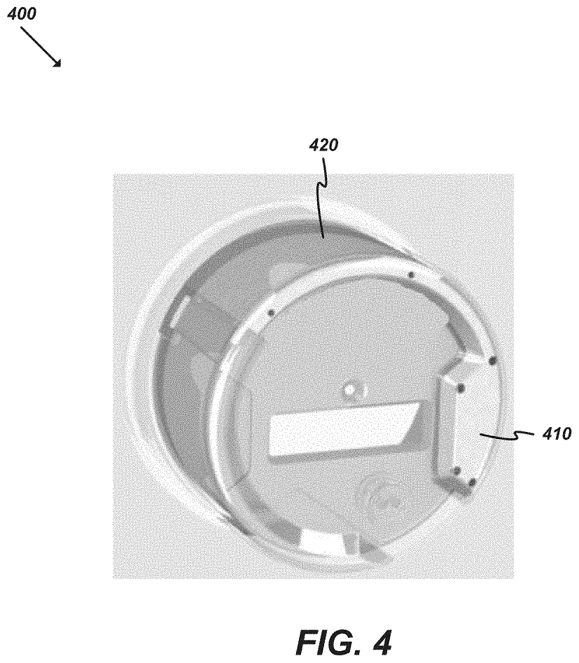

FIG. 4 illustrates a front perspective view of an exemplary smart cover 400 of some embodiments. In this example, the smart cover 100 includes an electronics module 410 and an antenna. The electronics module 410 may include the various components described above in reference to FIG. 3.

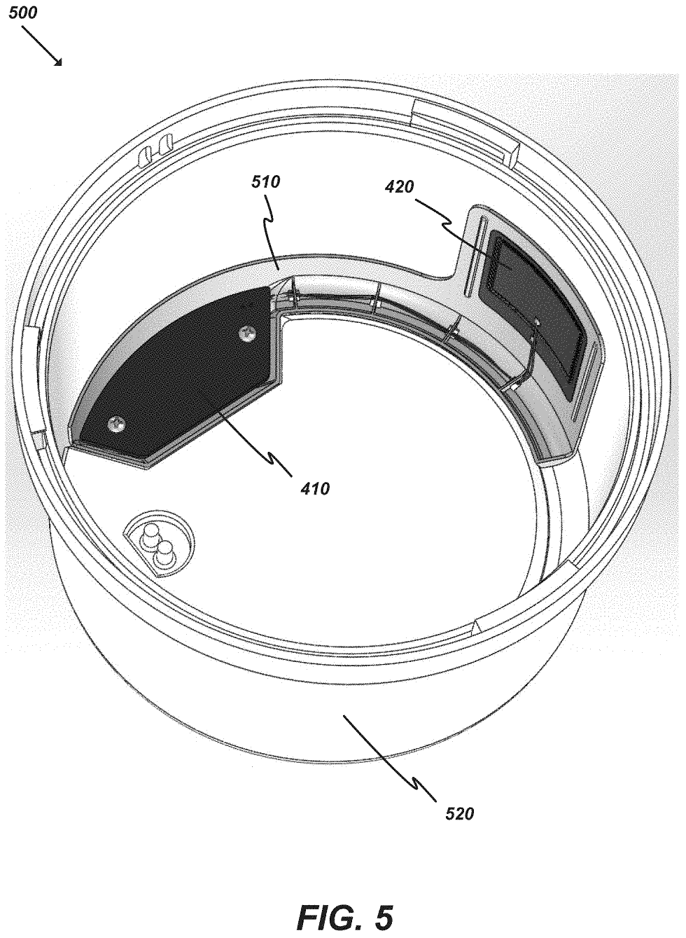

FIG. 5 illustrates a rear perspective view of an exemplary smart cover 500 of some embodiments. In this example, the electronics module 410 and antenna 420 are included at (or coupled to) a housing 510. The electronics module 410 may be coupled to the antenna 420 via one or more wires or other connectors. The housing 510 in this example may be configured to fit within a standard utility meter cover or other housing 520.

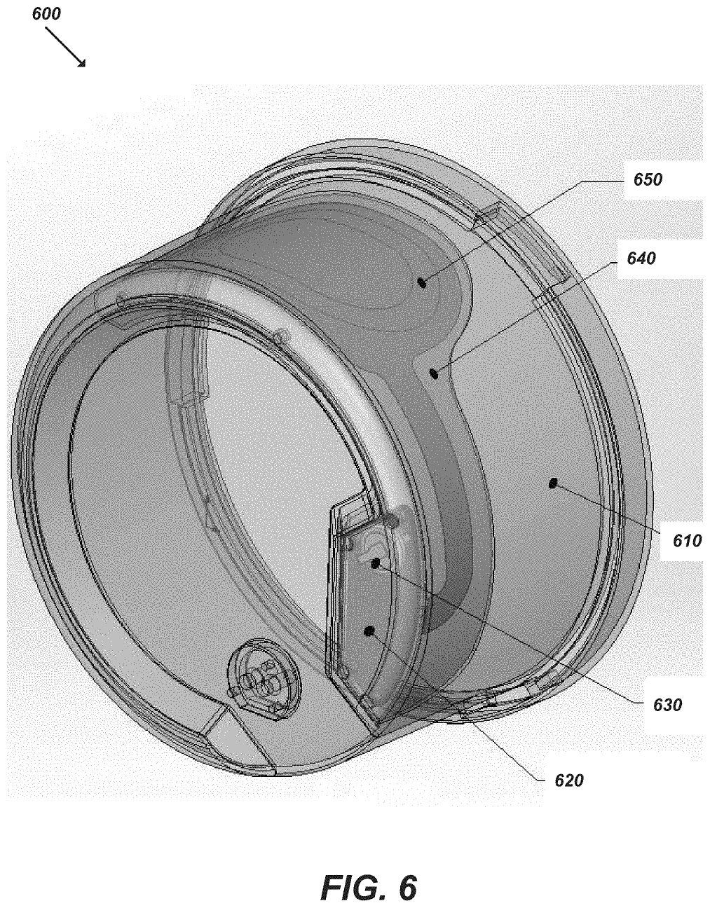

FIG. 6 illustrates a front perspective view of an exemplary smart cover 600 of some embodiments. In this example, the smart cover 600 includes a clear housing 610, an electronics module 620, a battery 630, a solar shield 640, and an antenna 650.

The solar shield 640 may protect various electronic components from interference or solar damage. The solar shield 640 may include various reflective or opaque elements.

Each of the example smart covers 400-600 may include a meter interface 310 (not shown) that may allow the smart cover to be communicatively coupled to the utility meter 110 via the utility meter interface 120. The meter interface 310 may include various cables, connectors, NFC components, and/or other appropriate elements that are able to communicatively couple the smart covers 100, 400, 500, or 600 to the meter 110.

Different embodiments of smart cover 100 may include various different housings that may be associated with various different types of meters. Such housings may typically fit the same connectors as existing housings such that upgrading a legacy meter 110 involves replacing a removable legacy cover with a smart cover 100. Various connectors of the smart cover 100 may be located or otherwise configured such that the meter interface 310 is coupled to the utility meter interface 120 when the smart cover 100 is coupled to the meter 110. For instance, various contact pins or pads of the smart cover 100 may align with complementary contact pins or pads of the meter 110 when the smart cover 100 is coupled to the meter 110.

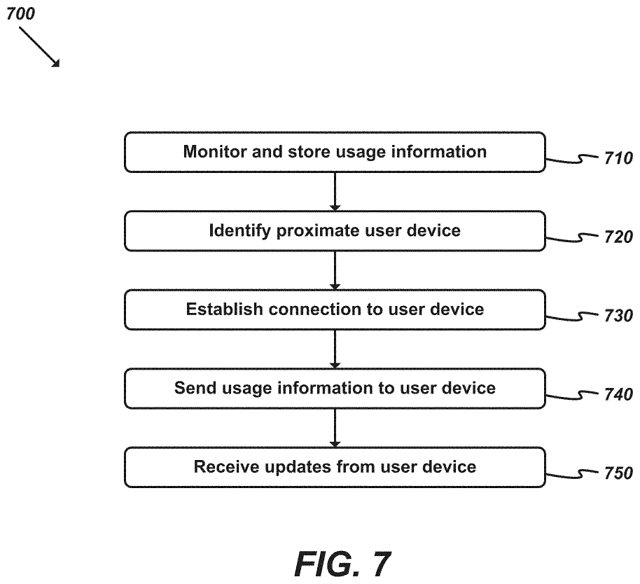

FIG. 7 illustrates an example process 700 for providing usage information from a smart cover to a user device and receiving updates at the smart cover from the user device. The process may allow technicians or other users to wirelessly interact with a legacy utility meter in order to receive usage information, update operating parameters of the meter, and/or otherwise interact with such a utility meter. The process may be performed when a smart cover 100 of some embodiments is installed or powered on. In some embodiments, process 700 may be performed by smart cover 100. Complementary processes may be performed by resources such as user device 130 and/or service manager 210.

As shown, process 700 may include monitoring and storing (at 710) usage information. Such usage information may be stored in local memory at the smart cover 100. Usage information may be received in various ways and various formats. For instance, utility meter interface 120 may provide an analog signal that is proportional to usage. As another example, utility meter interface 120 may provide a digital value representing total usage. Other information related to the meter may also be retrieved, such as timestamp(s) of most recent firmware or operating parameter update(s) at the meter, timestamp(s) of most recent meter reading(s), billing or payment information, and/or other appropriate information. Smart cover 100 may process such data in various ways, as appropriate. For instance, if an analog signal is received, the signal may be converted to a digital value and integrated or summed over time to calculate usage amount. As another example, if a digital value indicating total usage is received, such a value may be stored at regular intervals (e.g., every day, hour, minute, etc.) such that usage may be calculated for various time periods.

Proximate user devices may be identified (at 720) by transmitting a wireless beacon signal and receiving a response. Such a user device may be associated with a technician working for a utility company, for instance. The beacon signal may include a unique identifier associated with the smart cover 100 or other retrofit module. The response may include identifying information related to the user device 130 (e.g., serial number or subscriber number) and/or associated user (e.g., employee identifier) and/or other appropriate information. A connection may be established (at 730) using various appropriate protocols (e.g., Bluetooth, Wi-Fi, etc.) utilizing components such as transmitter/receiver 460.

As shown, process 700 may include sending (at 740) usage information to the user device. Such usage information may be sent via an application, web-based interface, and/or other resource of the user device using a component such as transmitter/receiver 360 across the connection established at 730.

In some embodiments, the user device may, in turn, send usage information to a server or other network resource of some embodiments (e.g., service manager 210). The server may retrieve user account information, previous usage and payment information, and/or other relevant information related to the meter, the associated property owner or manager, the utility, etc.

The user device or server may generate various updates based on the retrieved data. For instance, service may be activated or deactivated. As another example, firmware updates, pricing updates, and/or other updates may be generated.

Process 700 may include receiving (at 750) updates from the user device. The updates may be received via a wireless channel such as a Bluetooth link using a component such as transmitter/receiver 360 across the connection established at 730. Such updates may be received at the smart cover 100 and applied in various appropriate ways, such as sending activation or deactivation signals to the utility meter 110. Updates may be stored in local memory 330 of the smart cover 100 or provided to the utility meter 110 for storage or implementation, depending on the nature of the updates.

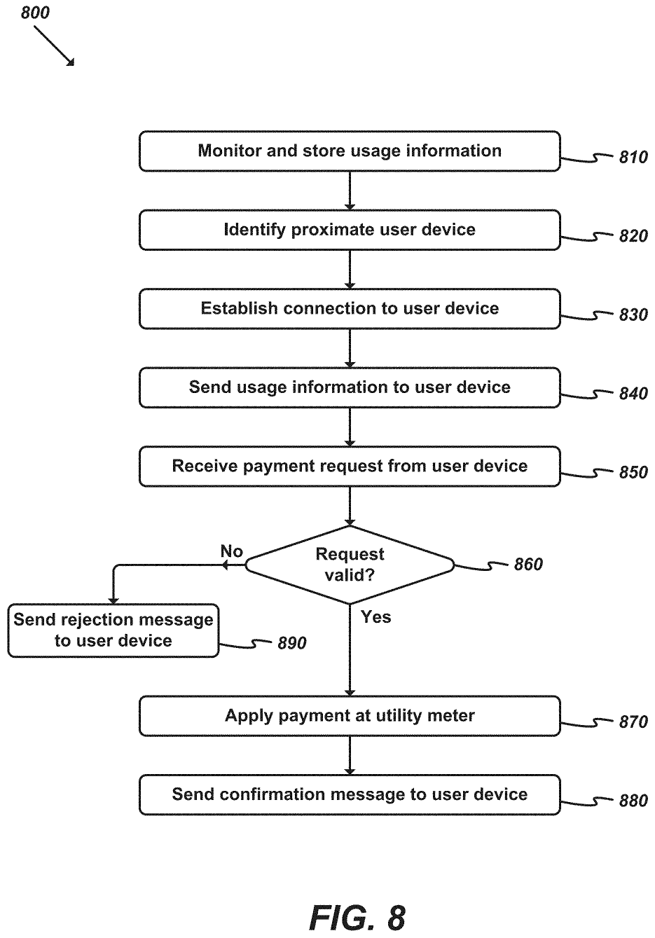

FIG. 8 illustrates an example process 800 for providing usage information to a user device and processing a payment received from the user device. Such a process may allow users to pay for service without requiring travel to, or exposure at, a facility such as a payment center. The process may be performed when a smart cover 100 of some embodiments is installed or powered on. In some embodiments, process 800 may be performed by smart cover 100. Complementary processes may be performed by resources such as user device 130 and/or service manager 210.

As shown, process 800 may include monitoring and storing (at 810) usage information as described above. Likewise, process 800 may include identifying (at 820) a proximate user device, establishing (at 830) a connection to the user device, and sending (at 840) usage information to the user device. In this case, the user device may be associated with a user such as an owner, landlord, tenant, etc.

Usage information may be formatted and provided in various appropriate ways, such as, total usage since last payment, amount due (or credit amount), usage since last technician reading, etc. In some embodiments, the user device may, in turn, send usage information to a server or other network resource of some embodiments (e.g., service manager 210). The server may retrieve user account information, previous usage and payment information, and/or other relevant information related to the meter, the associated property owner or manager, the utility, etc.

The server may generate a bill or invoice based on the retrieved information and may send the bill to the user device. At the user device, payment may be processed in various appropriate ways (e.g., user payment information such as credit card or bank account information may be utilized to apply payment). The payment may be verified at the server, and a confirmation may be generated and sent to the user device.

Process 800 may include receiving (at 850) a payment request from the user device. The payment request may include various authenticating information such that the smart cover 100 may validate the payment as legitimate (e.g., a digital certificate). The payment request may include a payment amount, information identifying a bank account, credit card, digital wallet, or other payment resource, and/or other appropriate information. The payment request may be received via a wireless channel such as a Bluetooth link using a component such as transmitter/receiver 360.

The process may include determining (at 860) whether the received request is valid. Such a determination may be made in various appropriate ways, using various evaluation algorithms. An element such as security module 350 may analyze a digital certificate or other representation of authenticity received from user device 130. In some embodiments, smart cover 100 may establish a secure connection via user device 130 to a resource such as service manager 210 or a network-accessible payment processing resource. The smart cover 100 and service manager 210 may communicate over the secure channel to validate the payment information (and/or user information or other appropriate information).

As shown, process 800 may include applying (at 870) the payment at the utility meter if the process determines (at 860) that the request is valid. The payment may be applied to operation of the smart cover 100 and/or meter 110 in various appropriate ways. For instance, upon payment (or communication of payment or account information) the smart cover 100 may enable (or re-enable) use of the service associated with the meter 110 by sending appropriate commands, messages, or data to the utility meter 110 via interfaces 120 and 310. Payment information (and/or other relevant information) may be stored or updated at the smart cover 100.

Process 800 may include sending (at 880) a confirmation message to the user device. The confirmation message may be sent over the wireless connection established at 830. The confirmation message may include information such as payment amount, payment source, timestamp, remaining amount due and associated deadline (if any), and/or other appropriate information (e.g., smart cover identifier, user device identifier, digital certificates, etc.). The confirmation message, or similar information, may be sent to other resources as necessary to finalize the transaction.

The process may include sending (at 890) a rejection message to the user device if the process determines (at 860) that the request is not valid. For instance, if the smart cover 100 is not able to validate a provided digital certificate or payment token, the request may be rejected. The rejection message may include codes or information indicating the reason for rejection. Such a rejection message may include similar information to the confirmation message, such as attempted payment amount, selected source, timestamp, and/or other appropriate information (e.g., smart cover identifier, user device identifier, digital certificates, etc.). Payment information (and/or other relevant information) may be stored or updated at the smart cover 100.

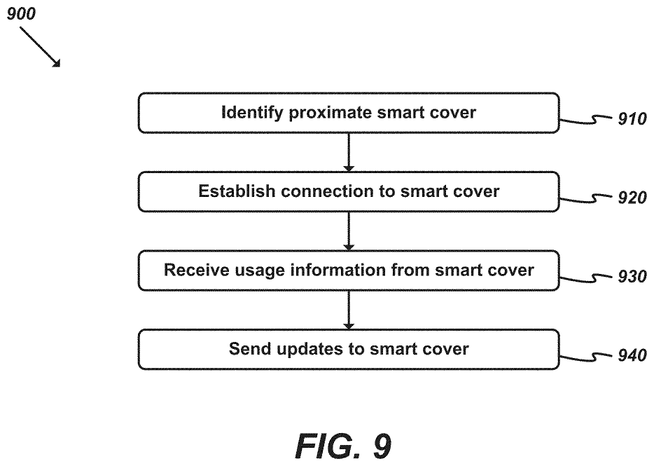

FIG. 9 illustrates an example process 900 for receiving usage data from a smart cover at a user device and providing updates to the smart cover 100 from the user device. The process may allow a user such as a technician to wirelessly collect usage data and update smart cover or meter settings. The process may be performed when a user device application of some embodiments is launched, when a web resource is accessed, and/or under other appropriate conditions. In some embodiments, process 900 may be performed by user device 130. Complementary processes may be performed by resources such as smart cover 100 and/or service manager 210.

As shown, process 900 may include identifying (at 910) a proximate smart cover and establishing (at 920) a connection to the smart cover. As discussed above, smart cover 100 may broadcast a beacon signal that is able to be received by user devices 130 within a transmission range of the smart cover 100. The user device 130 may execute an installed application or other resource that is able to respond to the beacon signal and establish a communication channel, such as a Bluetooth link, between the user device 130 and the smart cover 100.

The process may include receiving (at 930) usage information from the smart cover. Such usage information may be received via an application, web-based interface, and/or other resource of the user device using a component such as transmitter/receiver 360 across the connection established at 920.

In some embodiments, the user device may, in turn, send usage information to a server or other network resource of some embodiments (e.g., service manager 210). The server may retrieve user account information, previous usage and payment information, and/or other relevant information related to the meter, the associated property owner or manager, the utility, etc.

The user device or server may generate various updates based on the retrieved data. For instance, service may be activated or deactivated. As another example, firmware updates, pricing updates, and/or other updates may be generated.

As shown, process 900 may include sending (at 940) the updates to the smart cover. The updates may be sent via a wireless channel such as a Bluetooth link using a component such as transmitter/receiver 360 across the connection established at 920.

Although process 900 has been described with reference to a technician, one of ordinary skill would understand that such a process may be implemented at user devices associated with other user types. For instance, when an owner or tenant pays a utility bill via a process such as process 800, usage information may be sent to a resource such as service manager 210 and updates may be received via the user device 130 associated with a non-technician user.

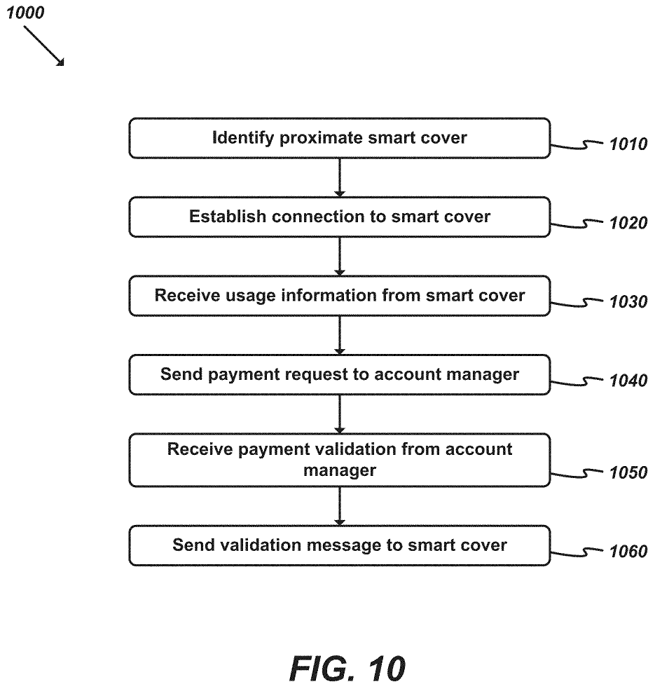

FIG. 10 illustrates an example process 1000 for receiving usage data from a smart cover at a user device and processing a payment from the user device to the smart cover. The process may allow a user such as a tenant or homeowner to wirelessly collect usage data and/or make a payment. The process may be performed when a user device application of some embodiments is launched, when a web resource is accessed, and/or under other appropriate conditions. In some embodiments, process 1000 may be performed by user device 130. Complementary processes may be performed by resources such as smart cover 100 and/or service manager 210.

As shown, process 1000 may include identifying (at 1010) a proximate smart cover and establishing (at 1020) a connection to the smart cover. As discussed above, smart cover 100 may broadcast a beacon signal that is able to be received by user devices 130 within a transmission range of the smart cover 100. The user device 130 may execute an installed application or other resource that is able to respond to the beacon signal and establish a communication channel, such as a Bluetooth link, between the user device 130 and the smart cover 100.

The process may include receiving (at 1030) usage information from the smart cover. Such usage information may be received via an application, web-based interface, and/or other resource of the user device using a component such as transmitter/receiver 360 across the connection established at 1020.

As shown, process 1000 may include sending (at 1040) a payment request to the account manager 210. The payment request may include various authenticating information such that the account manager 210 may validate the payment. The payment request may include information such as smart cover identifier, user device identifier, requested amount, payment source, timestamp, and/or other appropriate information. The payment request may be received via a wireless channel such as a Bluetooth link using a component such as transmitter/receiver 360. Some embodiments may process such requests at the user device without use of any external resource.

Process 1000 may include receiving (at 1050) a payment validation (or rejection) from the account manager 210. Such a validation message may include, for instance, a digital certificate, amount, and/or other relevant information.

The process may include sending (at 1060) the validation message to the smart cover over the connection established at 1020 if the payment is valid. The validation message may include information such as smart cover identifier, a digital certificate, payment amount, payment source, etc.

Alternatively, a rejection message may be sent to the smart cover 100 indicating that the payment request was not able to be validated if the payment was rejected. Such a rejection message may include information such as smart cover identifier, a requested amount, selected source, reason for rejection, and/or other appropriate information.

Process 1000 may store transaction information. Such stored information may include, for instance, smart cover identifier, payment amount, selected source, and/or other appropriate information.

One of ordinary skill in the art will recognize that processes 700-1000 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

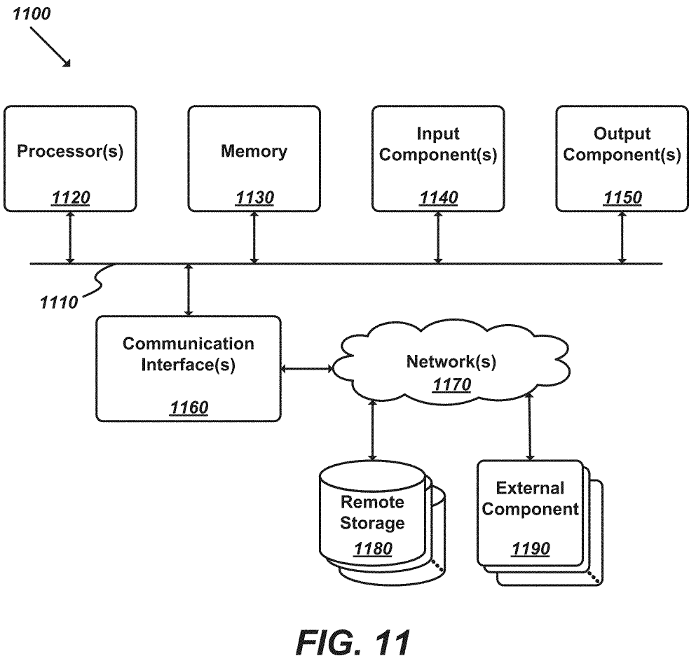

FIG. 11 illustrates a schematic block diagram of an exemplary device (or system or devices) 1100 used to implement some embodiments. For example, the systems and devices described above in reference to FIG. 1, FIG. 2, FIG. 3, FIG. 4, FIG. 5, and FIG. 6 may be at least partially implemented using device 1100. As still another example, the processes described in reference to FIG. 7, FIG. 8, FIG. 9, and FIG. 10 may be at least partially implemented using device 1100.

Device 1100 may be implemented using various appropriate elements and/or sub-devices. For instance, device 1100 may be implemented using one or more personal computers (PCs), servers, mobile devices (e.g., smartphones), tablet devices, wearable devices, and/or any other appropriate devices. The various devices may work alone (e.g., device 1100 may be implemented as a single smartphone) or in conjunction (e.g., some components of the device 1100 may be provided by a mobile device while other components are provided by a server).

As shown, device 1100 may include at least one communication bus 1110, one or more processors 1120, memory 1130, input components 1140, output components 1150, and one or more communication interfaces 1160.

Bus 1110 may include various communication pathways that allow communication among the components of device 1100. Processor 1120 may include a processor, microprocessor, microcontroller, digital signal processor, logic circuitry, and/or other appropriate processing components that may be able to interpret and execute instructions and/or otherwise manipulate data. Memory 1130 may include dynamic and/or non-volatile memory structures and/or devices that may store data and/or instructions for use by other components of device 1100. Such a memory device 1130 may include space within a single physical memory device or spread across multiple physical memory devices.

Input components 1140 may include elements that allow a user to communicate information to the computer system and/or manipulate various operations of the system. The input components may include keyboards, cursor control devices, audio input devices and/or video input devices, touchscreens, motion sensors, etc. Output components 1150 may include displays, touchscreens, audio elements such as speakers, indicators such as light-emitting diodes (LEDs), printers, haptic or other sensory elements, etc. Some or all of the input and/or output components may be wirelessly or optically connected to the device 1100.

Device 1100 may include one or more communication interfaces 1160 that are able to connect to one or more networks 1170 or other communication pathways. For example, device 1100 may be coupled to a web server on the Internet such that a web browser executing on device 1100 may interact with the web server as a user interacts with an interface that operates in the web browser. Device 1100 may be able to access one or more remote storages 1180 and one or more external components 1190 through the communication interface 1160 and network 1170. The communication interface(s) 1160 may include one or more application programming interfaces (APIs) that may allow the device 1100 to access remote systems and/or storages and also may allow remote systems and/or storages to access device 1100 (or elements thereof).

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1100 may perform various operations in response to processor 1120 executing software instructions stored in a computer-readable medium, such as memory 1130. Such operations may include manipulations of the output components 1150 (e.g., display of information, haptic feedback, audio outputs, etc.), communication interface 1160 (e.g., establishing a communication channel with another device or component, sending and/or receiving sets of messages, etc.), and/or other components of device 1100.

The software instructions may be read into memory 1130 from another computer-readable medium or from another device. The software instructions stored in memory 1130 may cause processor 1120 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A device, comprising:
one or more processors configured to:
collect, at a smart cover associated with a utility meter, usage information from the utility meter;
identify, at the smart cover, a proximate user device;
establish a wireless communication link between the smart cover and the proximate user device; and
send the usage information to the proximate user device.

2. The device of claim 1, wherein identifying a proximate user device comprises:
broadcasting a beacon signal; and
receiving a response to the beacon signal from the proximate user device.

3. The device of claim 1, the one or more processors further configured to receive updates to at least one operating parameter from the user device.

4. The device of claim 1, the one or more processors further configured to receive a payment request from the proximate user device.

5. The device of claim 4, the one or more processors further configured to evaluate the payment request to determine if the payment request is valid.

6. The device of claim 5, wherein evaluating the payment request comprises evaluating a digitally signed certificate included with the payment request.

7. The device of claim 5, wherein evaluating the payment request comprises:
establishing a connection from the smart cover to a service manager device via the user device;
sending a validation request to the service manager device; and
receiving a digitally signed response from the service manager.

8. A non-transitory computer-readable medium, storing a plurality of processor executable instructions to:
collect, at a smart cover associated with a utility meter, usage information from the utility meter;
identify, at the smart cover, a proximate user device;
establish a wireless communication link between the smart cover and the proximate user device; and
send the usage information to the proximate user device.

9. The non-transitory computer-readable medium of claim 8, wherein identifying a proximate user device comprises:
broadcasting a beacon signal; and
receiving a response to the beacon signal from the proximate user device.

10. The non-transitory computer-readable medium of claim 8, the plurality of processor executable instructions further to receive updates to at least one operating parameter from the user device.

11. The non-transitory computer-readable medium of claim 8, the plurality of processor executable instructions further to receive a payment request from the proximate user device.

12. The non-transitory computer-readable medium of claim 11, the plurality of processor executable instructions further to evaluate the payment request to determine if the payment request is valid.

13. The non-transitory computer-readable medium of claim 12, wherein evaluating the payment request comprises evaluating a digitally signed certificate included with the payment request.

14. The non-transitory computer-readable medium of claim 12, wherein evaluating the payment request comprises:
establishing a connection from the smart cover to a service manager device via the user device;
sending a validation request to the service manager device; and
receiving a digitally signed response from the service manager.

15. A method comprising:
collecting, at a smart cover associated with a utility meter, usage information from the utility meter;
identifying, at the smart cover, a proximate user device;
establishing a wireless communication link between the smart cover and the proximate user device; and
sending the usage information to the proximate user device.

16. The method of claim 15, wherein identifying a proximate user device comprises:
broadcasting a beacon signal; and
receiving a response to the beacon signal from the proximate user device.

17. The method of claim 15 further comprising receiving updates to at least one operating parameter from the user device.

18. The method of claim 15 further comprising receiving a payment request from the proximate user device.

19. The method of claim 18, further comprising evaluating the payment request to determine if the payment request is valid, wherein evaluating the payment request comprises evaluating a digitally signed certificate included with the payment request.

20. The method of claim 19, wherein evaluating the payment request comprises:
establishing a connection from the smart cover to a service manager device via the user device;
sending a validation request to the service manager device; and
receiving a digitally signed response from the service manager.
